(19) United States
(12) Patent Application Publication
(10) Pub. No.: US 2020/0114985 A1
(43) Pub. Date: Apr. 16, 2020

(54) AERODYNAMIC WING ASSEMBLY

(71) Applicant: FORD GLOBAL TECHNOLOGIES, LLC, Dearborn, MI (US)

(72) Inventors: Andrew Thomas Cunningham, Royal Oak, MI (US); Thomas Joseph Ciccone, Madison Heights, MI (US); Keith Weston, Canton, MI (US); Joshua Taylor Sharpe, Birmingham, MI (US); Matthew Arthur Titus, Livonia, MI (US); Joseph Ovalles Quinones, Dearborn, MI (US)

(21) Appl. No.: 16/156,945

(22) Filed: Oct. 10, 2018

(51) Int. Cl. B62D 35/00; B62D 37/02; G05D 3/20

(52) U.S. Cl. CPC B62D 35/007; B62D 37/02; B60Y 2400/414; B60Y 2400/412; G05D 3/20

(57) ABSTRACT

An aerodynamic wing assembly includes a stanchion, a wing and an actuator feature. The stanchion includes an internal passageway. The wing is supported on the stanchion and is displaceable between a home position and a deployed position. The actuator feature functions to displace the wing between the home position and the deployed position while being accommodated in the internal passageway.

### TECHNICAL FIELD

This document relates generally to the motor vehicle equipment field and, more particularly, to a new and improved aerodynamic wing assembly wherein the fasteners and the actuator feature are concealed from view within the stanchion supporting the wing of the wing assembly.

### BACKGROUND

It is possible to improve the handling performance and cornering speeds of performance motor vehicles by equipping those motor vehicles with large wings that generate significant down force. While such wings are very effective for their intended purpose, they are not without their shortcomings. More specifically, large wings of this type produce substantial drag which, unfortunately, reduces fuel economy and the top speed of the motor vehicle.

In an effort to address this shortcoming, motor vehicle manufacturers are relying upon active aerodynamic wing assemblies wherein the attack angle of the wing is adjusted by increasing the attack angle to produce increased down force when cornering and reducing the attack angle to decrease drag at other times to thereby improve fuel economy and increase top speed.

Significantly, state of the art active aerodynamic wing assemblies incorporate exposed fasteners that tend to detract from the aesthetic qualities of the motor vehicle. Such exposed fasteners allow the wing or air foil of the wing assembly to be subject to theft. Further, unless such fasteners are made from stainless steel, they have a tendency to rust over time blemishing the appearance of the motor vehicle.

This document relates to a new and improved aerodynamic wing assembly incorporating a wing that may be displaced between a home position and a deployed position while including an actuator feature and fasteners accommodated within an internal passageway of a supporting stanchion where they are concealed from the elements and hidden from view.

### SUMMARY

In accordance with the purposes and benefits described herein, a new and improved aerodynamic wing assembly is provided. That aerodynamic wing assembly comprises: (a) a stanchion including an internal passageway, (b) a wing supported on the stanchion and displaceable between a home position and a deployed position and (c) an actuator feature. The actuator feature displaces the wing between the home position and the deployed position. The actuator feature is accommodated in the internal passageway.

More specifically, the wing may include a first pivot point at the stanchion and a second pivot point at the actuator feature. Still further, the first pivot point and the second pivot point may both be concealed from view within the internal passageway when the wing is in the home position.

Still further, the actuator feature may comprise a linear motion mechanism. In one or more of the many possible embodiments of the aerodynamic wing assembly, that linear motion mechanism may comprise a cylinder and cooperating actuator rod. In one or more of the many possible embodiments of the aerodynamic wing assembly, that linear motion mechanism may comprise a drive motor and a cooperating rack and pinion. In one or more of the many possible embodiments of the aerodynamic wing assembly, that linear motion mechanism may comprise a drive screw. That drive screw may be connected to a drive motor. In one or more of the many possible embodiments of the aerodynamic wing assembly, the actuator feature may be a drive motor and a cooperating cam driven by the drive motor and connected to the wing.

The first pivot point may include a first lug carried on the wing and a first pivot pin connecting the first lug to the stanchion. The second pivot point may include a second lug carried on the wing and a second pivot pin connecting the second lug to the actuator feature.

The actuator feature may further include a control module adapted to displace and adjust an attack angle of the wing in response to at least one input parameter. That input parameter may be selected from a group of parameters consisting of motor vehicle speed inputs, motor vehicle throttle inputs, motor vehicle brake inputs, motor vehicle pitch, squat and roll inputs, motor vehicle yaw inputs and combinations thereof.

In the following description, there are shown and described several preferred embodiments of the aerodynamic wing assembly. As it should be realized, the aerodynamic wing assembly is capable of other, different embodiments and its several details are capable of modification in various, obvious aspects all without departing from the aerodynamic wing assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the aerodynamic wing assembly and together with the description serve to explain certain principles thereof.

FIG. 1 is a perspective view of the rear end of a motor vehicle equipped with the new and improved aerodynamic wing assembly showing the wing of the aerodynamic wing assembly held on two stanchions overlying the top of the trunk lid of the motor vehicle.

FIG. 2 is a schematic side illustration of the aerodynamic wing assembly showing the wing of the aerodynamic wing assembly in the home position wherein the attack angle is minimized to reduce down force and drag and thereby maximize the fuel economy and the top speed of the motor vehicle.

FIG. 3 is a view similar to FIG. 2 but illustrating the wing in a deployed position wherein the attack angle is increased to increase down force and thereby increase traction and the cornering speeds of the motor vehicle.

FIG. 4A is a schematic illustration of one possible embodiment of the aerodynamic wing assembly wherein the actuator feature is a linear motion mechanism in the form of a cylinder and cooperating actuator rod.

FIG. 4B is a schematic illustration of another possible embodiment of the aerodynamic wing assembly wherein the actuator feature is a linear motion mechanism in the form of a drive motor and a cooperating rack and pinion.

FIG. 4C is a schematic illustration of yet another possible embodiment of the aerodynamic wing assembly wherein the actuator feature is a linear motion mechanism in the form of a drive screw.

FIGS. 5A and 5B are schematic side elevational views of an alternative embodiment of the wing assembly wherein the actuator feature is a cooperating cam and drive motor. In FIG. 5a, the wing is illustrated in the home position. In FIG. 5B, the wing is illustrated in the fully deployed position.

FIG. 6 is a schematic block diagram of the control module connected to the actuator that displaces the wing between the home and deployed positions.

Reference will now be made in detail to the present preferred embodiments of the aerodynamic wing assembly, examples of which are illustrated in the accompanying drawing figures.

### DETAILED DESCRIPTION

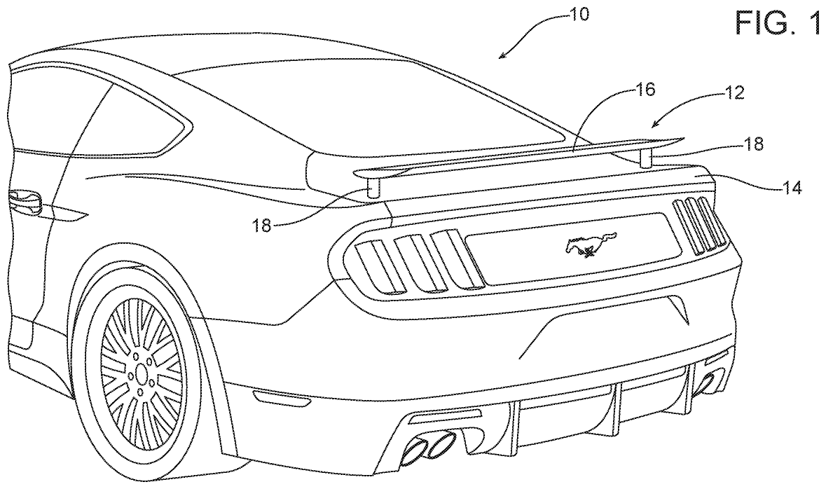

Reference is now made to FIG. 1 illustrating a motor vehicle 10 equipped with a new and improved aerodynamic wing assembly 12 at the rear of the vehicle overlying the trunk lid 14. As illustrated, the aerodynamic wing assembly 12 includes a wing 16 supported at spaced locations by two stanchions 18.

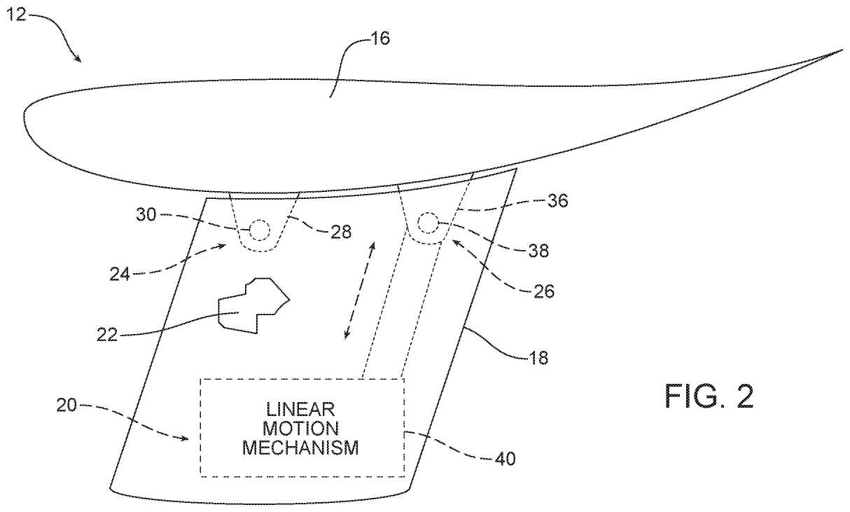

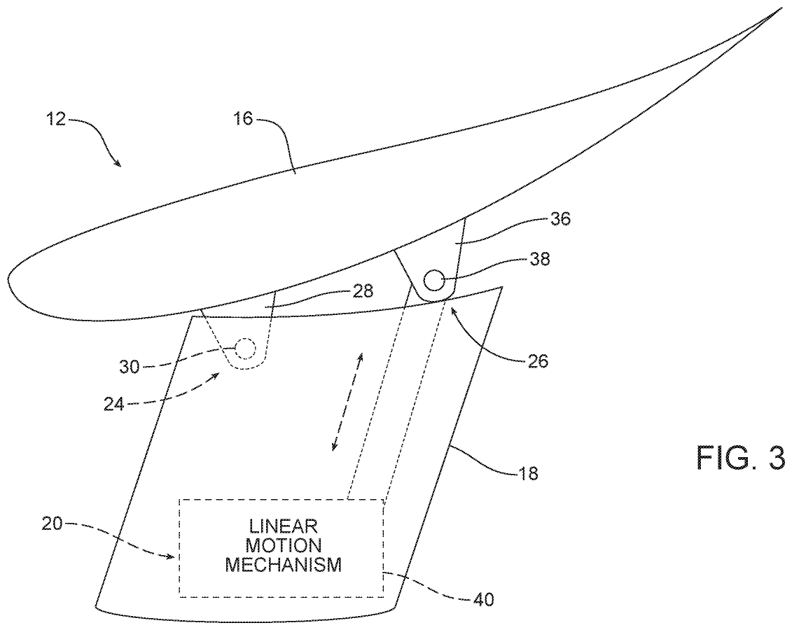

Reference is now made to FIGS. 2 and 3 illustrating one of the stanchions 18 in detail. The second stanchion 18 may include a similar or identical structure. As illustrated in FIGS. 2 and 3, the wing 16 is supported on the stanchion 18 and the wing is displaceable between a home position illustrated in FIG. 2 and a deployed position illustrated in FIG. 3. An actuator feature 20 displaces the wing 16 between the home position and the deployed position. In the illustrated embodiment, that actuator feature 20 is accommodated within an internal passageway 22 provided in the stanchion 18.

As further illustrated in FIGS. 2 and 3, the wing 16 includes a first pivot point 24 at the stanchion 18 and a second pivot point 26 at the actuator feature 20. More particularly, the first pivot point 24 may comprise a lug 28 fixed to the wing 16 and a cooperating trunnion 30 carried on the stanchion 18. As should be appreciated, the first pivot point 24 of the illustrated embodiment is fixed with respect to the stanchion 18.

The second pivot point 26 comprises a lug 36 fixed to the wing 16 in a motor vehicle direction rearward of the first lug 28. The lug 36 is received over and pivots on the trunnion 38 fixed to the actuator feature 20. As should be appreciated from viewing FIG. 1, both the first pivot point 24 and the second pivot point 26 are concealed from view within the internal passageway 22 of the stanchion 18 when the wing 16 is in the home position.

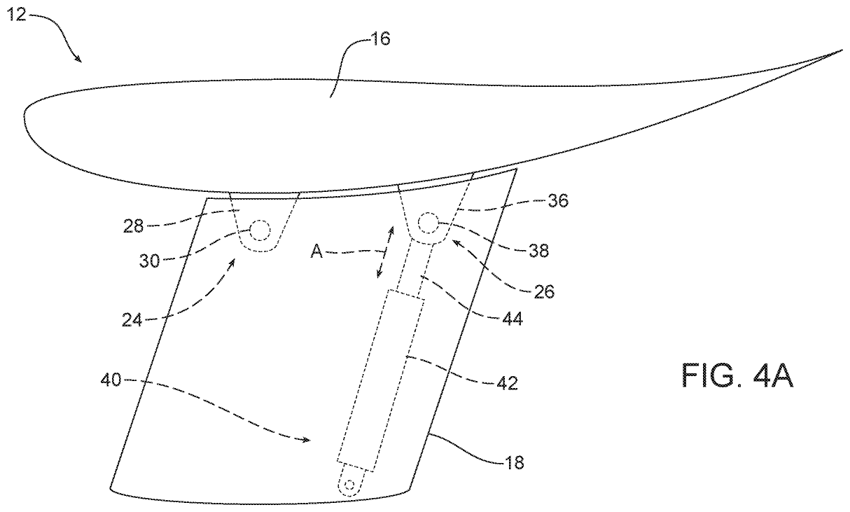

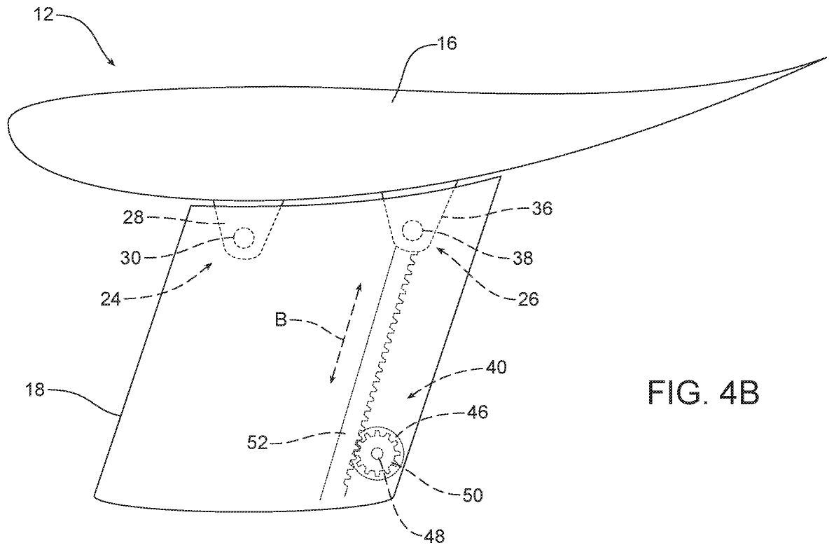

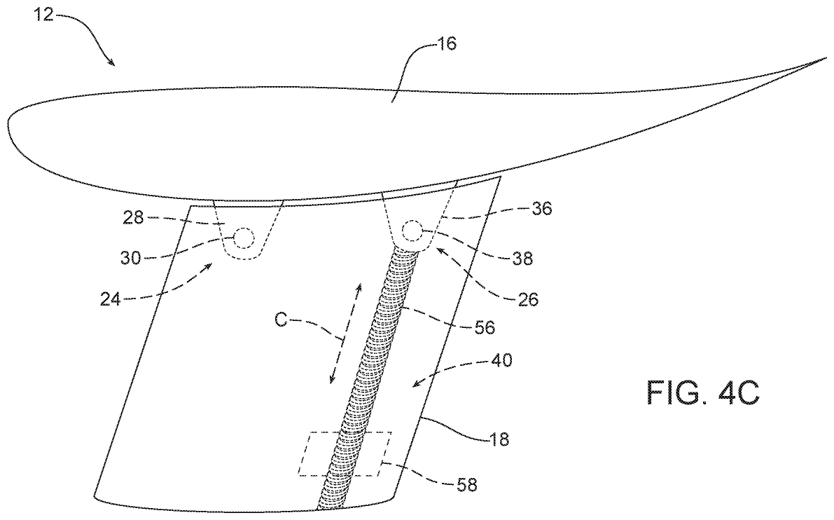

The actuator feature 20 may comprise a wide variety of different mechanisms including, but not necessarily limited to, linear motion mechanisms 40 suitable for adjusting the attack angle of the wing 16. For example, as illustrated in FIG. 4A, the linear motion mechanism 40 may comprise a hydraulic or pneumatic cylinder 42 secured in position within the stanchion 18 and a cooperating actuator rod 44 connected to the wing 16 by the trunnion 38 and cooperating lug 36. As should be appreciated, the actuator rod 44 is extended from or retracted into the cylinder 42 to adjust the attack angle of the wing 16 about the fixed first pivot point 24. Note action arrow A.

As illustrated in FIG. 4B, the linear motion mechanism 40 may comprise a drive motor 46 having an output shaft 48 connected to a pinion 50. Pinion 50 engages a cooperating rack 52 that is displaced upward or downward (note action arrow B) within the internal passageway of the stanchion 18 in order to adjust the attack angle of the wing 16. As should be appreciated, the distal end of the rack 52 includes the trunnion 38 that is connected to the lug 36 of the wing 16. The rack 52 may slide along a guide track (not shown) fixed to the stanchion 18 within the internal passageway 22.

As illustrated in FIG. 4C, the linear motion mechanism 40 may also comprise a drive screw 56. In one possible embodiment, the drive screw 56 is accessed by opening the trunk lid 14 and manually turning the drive screw 56 with an appropriate tool in order to adjust the drive screw up and down (note action arrow C) and thereby adjust the attack angle of the wing 16. In another possible embodiment, as illustrated in FIG. 4C, the drive screw 56 is adjusted by means of a cooperating drive motor 58 fixed within the internal passageway 22 of the stanchion 18.

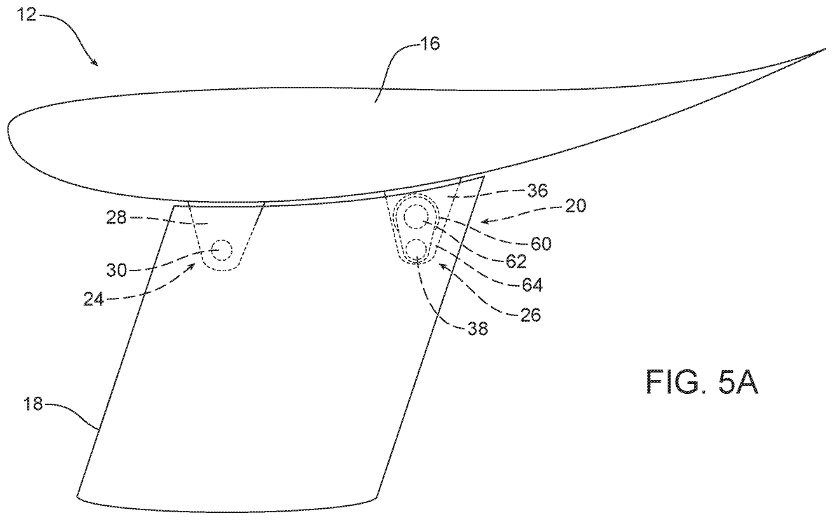

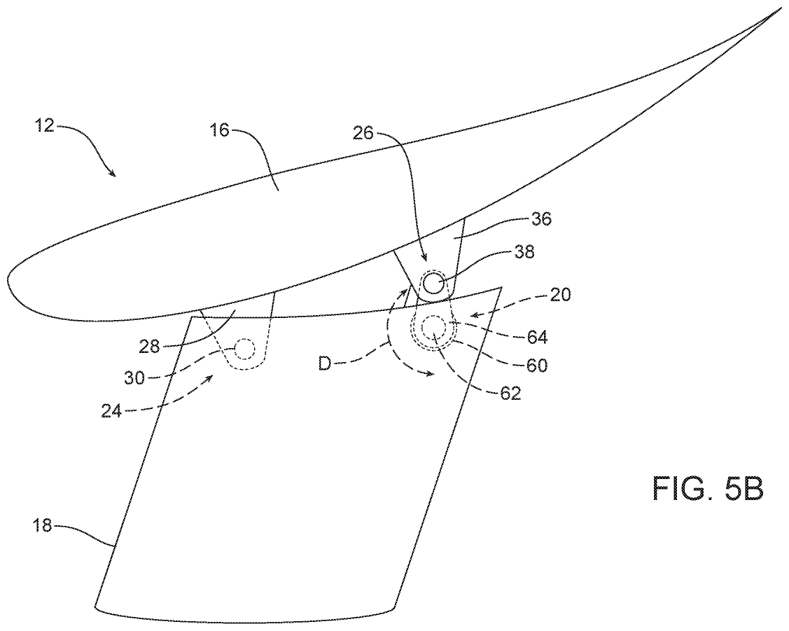

In the embodiment illustrated in FIGS. 5A and 5B, the actuator feature 20 comprises a drive motor 60, in the form of a servo motor, having an output shaft 62 connected to a cam 64. The cam 64 carries the trunnion 38 connected to the lug 36 of the wing 16. In this embodiment, the drive motor 60 functions to rotate (note action arrow D in FIG. 5B) the cam 64 and adjust the attack angle of the wing 16.

The actuator feature 20, such as the cylinder 42 of the embodiment illustrated in FIG. 4A, the drive motor 46 of the embodiment illustrated in FIG. 4B, the drive motor 58 of the embodiment illustrated in FIG. 4C, and the drive motor 60 of the embodiment illustrated in FIGS. 5A and 5B, may all be manually activated in order to adjust the attack angle of the wing 16 as desired by the operator.

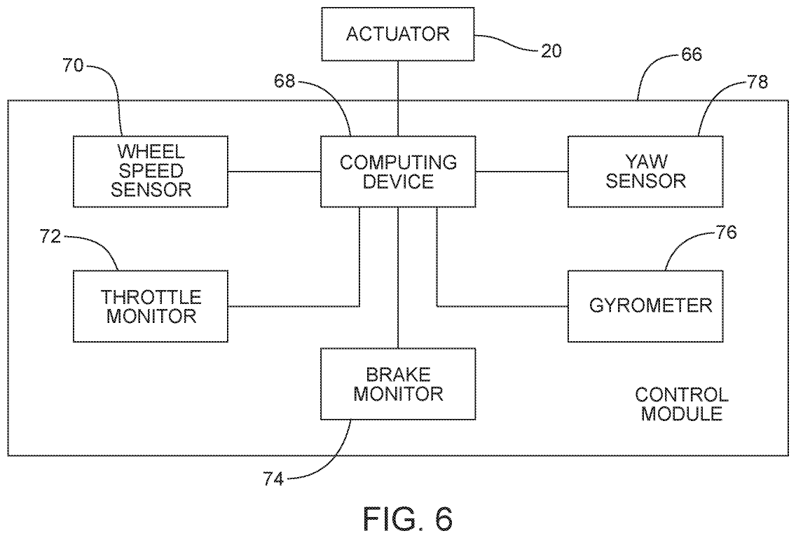

Alternatively, in some embodiments of the aerodynamic wing assembly 12, the actuator feature 20 may further include a control module 66 adapted to displace and adjust the attack angle of the wing 16 in response to at least one input parameter. See FIG. 6. That input parameter may be selected from a group of parameters consisting of motor vehicle speed inputs, motor vehicle throttle inputs, motor vehicle brake inputs, motor vehicle pitch, squat and roll inputs, motor vehicle yaw inputs and combinations thereof. Thus, it should be appreciated that the aerodynamic wing assembly 12 may be an entirely active wing assembly adapted to displace the wing 16 into a deployed position as illustrated in FIG. 3 in order to increase the attack angle and generate increased down force for improved stability and faster cornering speeds when cornering while also displacing the wing into the home position illustrated in FIG. 2 to reduce drag and thereby increase fuel economy and top speed when the motor vehicle is being operated on straight-away or other high speed road sections.

The control module 66 may comprise a computing device 68, such as a dedicated microprocessor or an electronic control unit (ECU) operating in accordance with instructions from appropriate control software. Thus, the control module 66 may comprise one or more processors, one or more memories and one or more network interfaces all in communication with each other over one or more communication buses. The control module 66 may also comprise various sensor and monitoring devices. For example, the control module 66 may include a wheel speed sensor 70 to monitor vehicle speed and provide input data respecting instant vehicle speed to the computing device 68.

The control module 66 may include a vehicle throttle monitor 72 and a brake monitor 74 to provide instant throttle input data and brake input data to the computing device 68. The computing device 68 is configured to direct the actuator 20 to displace the wing 16 (a) toward the home position illustrated in FIG. 2 in response to throttle input data that increase acceleration and (b) toward the fully deployed position in FIG. 3 in response to brake input data that increase deceleration.

The control module 66 may include one or more onboard gyrometers 76 to provide instant motor vehicle pitch, squat and roll input data to the computing device 68. Such inputs assist the computing device 68 to determine whether the driver is accelerating, braking and/or turning. If the driver is turning, the vehicle will pitch in the fore direction and then roll—prompting the computing device 68 to direct the actuator 20 to displace the wing 16 toward the fully deployed position and increase the attack angle for greater downforce. Near the end of the turn, the driver will accelerate causing the vehicle to squat—prompting the computing device 68 to direct the actuator 20 to lower the wing 16 toward the home position and reduce drag after the turn is completed.

The control module 66 may also include a yaw sensor 78 to help determine if the motor vehicle is turning—prompting the computing device 68 to direct the actuator 20 to move the wing 16 toward the fully deployed position so as to add downforce for improved cornering.

The control module 66 may be further configured to always return the wing 16 to the home position illustrated in FIG. 2 when the ignition switch of the motor vehicle is deactivated. In the home position, the first pivot point 24 and second pivot point 26 are fully concealed within the internal passageway 22 of the stanchion 18 where they are hidden from view and also protected from environmental elements such as rain and snow which could cause unsightly rusting and potentially adversely affect the efficiency of operation of the first pivot point 24 and second pivot point 26 over an extended period of time. Advantageously, the aerodynamic wing assembly 12 disclosed herein may be a fully active aerodynamic wing assembly 12 under continuous control of the control module 66 while all fasteners, including the first pivot point 24 and second pivot point 26, securing the wing 16 to the stanchions 18 are concealed from view for aerodynamic advantage and enhanced aesthetics.

The foregoing has been presented for purposes of illustration and description. It is not intended to be exhaustive or to limit the embodiments to the precise form disclosed. Obvious modifications and variations are possible in light of the above teachings. For example, the aerodynamic wing assembly illustrated in drawing FIG. 1 includes a wing 16 supported on two stanchions 18. Fewer or more stanchions may be provided for this purpose. All such modifications and variations are within the scope of the appended claims when interpreted in accordance with the breadth to which they are fairly, legally and equitably entitled.

What is claimed:

1. An aerodynamic wing assembly, comprising:
a stanchion including an internal passageway;
a wing supported on said stanchion and displaceable between a home position and a deployed position; and
an actuator feature displacing said wing between said home position and said deployed position, said actuator feature being accommodated in said internal passageway.

2. The aerodynamic wing assembly of claim 1, wherein said wing includes a first pivot point at said stanchion and a second pivot point at said actuator feature.

3. The aerodynamic wing assembly of claim 2, wherein said first pivot point and said second pivot point are both concealed from view within said internal passageway when said wing is in said home position.

4. The aerodynamic wing assembly of claim 3, wherein said actuator feature is a linear motion mechanism.

5. The aerodynamic wing assembly of claim 4, wherein said linear motion mechanism comprises a cylinder and cooperating actuator rod.

6. The aerodynamic wing assembly of claim 4, wherein said linear motion mechanism comprises a drive motor and a cooperating rack and pinion.

7. The aerodynamic wing assembly of claim 4, wherein said linear motion mechanism comprises a drive screw.

8. The aerodynamic wing assembly of claim 7, wherein said drive screw is connected to a drive motor.

9. The aerodynamic wing assembly of claim 3, wherein said actuator feature is a drive motor and a cooperating cam driven by said drive motor and connected to said wing.

10. The aerodynamic wing assembly of claim 2, wherein said first pivot point includes a first lug carried on said wing and a first trunnion connecting said first lug to said stanchion.

11. The aerodynamic wing assembly of claim 10, wherein said second pivot point includes a second lug carried on said wing and a second trunnion connecting said second lug to said actuator feature.

12. The aerodynamic wing assembly of claim 1, wherein said actuator feature further includes a control module adapted to displace and adjust an attack angle of said wing in response to at least one input parameter.

13. The aerodynamic wing assembly of claim 12, wherein said input parameter is selected from a group of parameters consisting of motor vehicle speed inputs, motor vehicle throttle inputs, motor vehicle brake inputs, motor vehicle pitch, squat and roll inputs, motor vehicle yaw inputs and combinations thereof.

14. The aerodynamic wing assembly of claim 1, wherein said actuator feature is a linear motion mechanism.

15. The aerodynamic wing assembly of claim 14, wherein said linear motion mechanism comprises a cylinder and cooperating actuator rod.

16. The aerodynamic wing assembly of claim 14, wherein said linear motion mechanism comprises a drive motor and a cooperating rack and pinion.

17. The aerodynamic wing assembly of claim 14, wherein said linear motion mechanism comprises a drive screw.

18. The aerodynamic wing assembly of claim 17, wherein said drive screw is connected to a drive motor.

19. The aerodynamic wing assembly of claim 1, wherein said actuator feature is a drive motor and a cooperating cam driven by said drive motor and connected to said wing.
